(19) United States
(12) Patent Application Publication
(10) Pub. No.: US 2008/0106042 A1
(43) Pub. Date: May 8, 2008

(54) Rotary Seal

(76) Inventors: Alan James Roddis, Sheffield (GB); Andrew Colverson, Doncaster (GB)

Correspondence Address: EDWIN D. SCHINDLER, FIVE HIRSCH AVENUE, P.O. BOX 966, CORAM, NY, 11727-0966, US

(21) Appl. No.: 11/813,256

(22) PCT Filed: Dec. 30, 2005
(86) PCT No.: PCT/GB05/05112

§ 371 Date: Aug. 18, 2007

(30) Foreign Application Priority Data
Dec. 30, 2004 (GB) 0428450.1

(51) Int. Cl. F16J 15/34

(52) U.S. Cl. 277/399

(57) ABSTRACT

A rotary seal has a floating seal face in a sealing relationship with a stationary seal face, and a fluid collection cavity adjacent the floating seal face and the stationary seal face. The seal further includes a device for introducing a lubricant into the vicinity of the fluid collection cavity and a device for promoting coalescence of the lubricant, so that the lubricant accumulates in the fluid collection cavity and lubricates the seal faces.

### FIELD OF THE INVENTION

This invention relates to rotary seals and is concerned with their use in rotating equipment and especially devices which prevent the ingress of a fluid or solid to an area which results in deterioration of equipment life. Such devices are often referred to as bearing protectors or bearing isolators. However, the use of such rotary seals extends well beyond the protection of a bearing in rotating equipment. Accordingly, while reference will be made below to bearing protectors, it should be understood that this term is used, as far as the invention is concerned, in connection with mechanical and other seals having wider uses.

### BACKGROUND TO THE INVENTION

The purpose of a bearing protector is to prevent the ingress of fluid, solids and/or debris entering a bearing arrangement and thereby prevent the failure of the bearing. Bearing protectors generally fall into two categories: repeller or labyrinth bearing protectors; and mechanical seal bearing protectors.

A repeller bearing protector includes a component which is mounted for rotation about a shaft and axially fixed in relation thereto. For example, the shaft may be that of a pump or other piece of rotating equipment. The protector includes a static component which is also axially fixed and is butted or secured to the stationary part of the equipment.

The rotating component typically has a complex outer profile which is located adjacent to an inner complex profile of the stationary component. Together these complex profiles provide a tortuous path preventing the passage of the unwanted materials.

A repeller bearing protector normally works only during the operation of the equipment. When the equipment is static, the complex labyrinth design is unable to hold a fluid level which, in horizontal application, is at a higher radial level than the inlet position of the protector.

Mechanical seals are used in all types of industries to seal a variety of different process media and operating conditions. A mechanical seal bearing protector overcomes the static limitations of the labyrinth design by the use of two opposing seal faces. Such a protector includes a “floating” component which is mounted for axial movement about the rotary shaft of, for example, a pump and a “static” component which is axially fixed and is typically secured to a housing. The floating component has a flat annular end seal face which is directed towards a corresponding seal face of the static component. The floating component is urged towards the static component to close the seal faces together to form a sliding face seal, usually by means of one or more spring members. The rotating component, which in practice could be either the floating or the static component, is referred to as the rotary component. The other component does not rotate and is referred to as the stationary component. A rotary seal is one whose floating component is rotary and, in a stationary seal, the floating component is stationary. If the sliding seal between the rotary and the stationary components is assembled and pre-set to despatch from the manufacturer, the seal is termed a “cartridge seal”. If the rotary and the stationary components are despatched in unassembled condition by the manufacturer, the seal is termed a “component seal”. The term “inboard” defines the area adjacent to the process media and the term “outboard” defines the area adjacent the atmospheric side.

Desirably, a mechanical seal bearing protector prevents the ingress of fluid etc. irrespective of the direction of shaft rotation.

Bearing protectors are generally very compact at least as far as their axial length is concerned. Typically they are used to replace so-called lip seals and are fitted into spaces previously occupied by such seals. In order to maintain a compact axial length, the floating component may be energised by one or more magnets in either attracting mode (U.S. Pat. No. 5,078,411 Geco) or repelling mode (EP 0105616 Burles).

Furthermore, our co-pending patent application (PCT/GB03/02941 Roddis) defines a dual mechanical seal bearing protector, whereby two independent stator seal faces are attracted to a common rotor seal face by one or more magnets.

The major benefit of mechanical seal bearing protectors is that they provide a hermetic sealing solution. This means that they prevent the ingress or egress of fluid. However, all contacting mechanical seal bearing protectors operate on a fluid film between the counter rotating seal faces. In marginal lubrication applications the fluid film is typically very thin which may cause heat generation and/or seal face deterioration. Seal face deterioration will lead to loss of the hermetic seal.

There is an increasing trend for industry to adopt oil-misting techniques to lubricate their bearing arrangements in rotating equipment. Oil misting involves a separate supply unit, which is connected, supply and return, to the bearing cavity of the rotating equipment. Said supply unit provides an oil mist at a velocity in the order of 0.3 cc/hr for a 1.000″/25 mm bearing bore (Page 25—Oil Mist lubrication, Bloch & Shamin 1998). However 0.3 cc/hr velocity is insufficient to adequately lubricate and cool a mechanical seal face and therefore a conventional mechanical seal face bearing protection solution may fail to function correctly under such conditions.

Unfortunately, a non-contacting bearing protector, by its nature, has an oil mist escape path between the counter rotating components. This leads to oil mist being evacuated into the environment. Not only does this lead to loss of oil and therefore significantly increases the running cost of the supply unit, in many parts of the world, the environmental issues are unacceptable.

It is therefore highly desirable to provide a hermetic mechanical seal bearing protector, which can operate in a minimal lubrication condition, as typically found in oil mist applications.

### STATEMENTS OF THE INVENTION

According to the present invention there is provided a rotary seal having a floating seal face in sealing relationship with a stationary seal face, a fluid collection cavity adjacent said seal faces, means for introducing a lubricant into the vicinity of said cavity, means for promoting the coalescence of said lubricant whereby said lubricant accumulates in said cavity and lubricates said seal faces.

The promoting means may be, for instance, at least one of a textured seal face surface, one or more grooves or slots and a pumping element. Accordingly, the cavity is in fluid communication with said seal faces.

The seal may be in the form of, for instance, a mechanical seal or other type of bearing protector.

The lubricant introducing means may be, for instance, an inlet port provided in the seal body or an item to which the seal is, in use, attached. In use a device for creating an oil mist may be attached to such an inlet.

The lubricant is typically one providing insufficient lubrication to the seal faces. For instance, it may be provided in the form of an oil mist or other “marginal” lubricating fluid. By “marginal” is meant a lubricant which is insufficiently present without coalescence to increase the amount of lubricant per unit volume in contact with the seal faces.

Preferably, said seal faces are respectively floating and stationary with respect to the longitudinal axis of the seal.

The rotary seal may be, for instance, a hermetic seal or a repeller bearing protector and may be in the form of a mechanical seal.

Preferably, said floating seal face is urged by a magnetic biasing means towards said stationary seal face. Although reference is made to a magnetic biasing means, it should be understood that such magnetic means may be replaced either wholly or partially by another biasing member, for instance, some form of spring or resilient elastomeric member, including a bellows-like arrangement.

Preferably, said floating seal face and said magnetic biasing means are rotationally fixed relative to each other and said stationary seal face is free to rotate relative to said floating seal face.

Preferably, the seal includes two pairs of sealing faces. Preferably, at least one seal face is textured and preferably, the textured seal face is the face adjacent to the primary sealed fluid which may be an oil mist. Preferably, the textured seal face is textured from the innermost radial part of the seal face to the outermost part of the seal face. Preferably, the sealed fluid is able to pass between the seal faces and thereby accumulate in a radial cavity adjacent to the hermetic seal face. By “textured” it is meant that a seal face has ridges, grooves or other structure such that channels are provided between the said seal face and its opposed seal face.

Accordingly, it is preferred that, adjacent to the hermetic seal face, there is a radially and/or longitudinally extending cavity which captures and retains coalesced oil from the oil mist. In effect, the function of the textured seal face is to promote the coalescence of the oil mist by energising the fluid so that it can be put into communication with the hermetic seal face.

Other coalescence promoters may be used. For instance, an engraved seal face or a suitable labyrinth arrangement may be employed. Essentially, any arrangement which promotes oil mist coalescence and then the retention of the coalesced fluid adjacent to a hermetic seal face, which prevents it from entering the bearing cavity, may be used in the present invention.

Preferably, one or more magnets are arranged within the seal such that, in use, the magnets are non-rotating and thus mounted in a non-rotating housing. Alternatively, one or more rotating magnets may be used, these being mounted in a rotating element which is either longitudinally floating or longitudinally static.

Preferably, the magnet or magnets are mounted radially outwards of the seal face. A radial support may be provided to both support and circumferentially space apart a plurality of magnets.

A seal of the present invention preferably includes a housing which has at least one radially outwardly positioned equipment chamber location feature. Such a feature is located adjacent to a radially extending groove which contains at least one elastomeric member for sealing the housing to the equipment chamber. The arrangement may be provided with at least two radially outwardly positioned equipment chamber location features, with correspondingly at least two radially extending grooves. Both of the grooves contain at least one elastomeric member for sealing the housing to the equipment chamber. Preferably the two location features are radially and/or longitudinally displaced relative to each other.

The seal may include a housing which is provided with a radially extending hole connecting the outermost and innermost surfaces of the housing.

At least one of the seal faces in a seal of the invention may be segmented. The seal may include two substantially identical pairs of contacting seal faces which may be in modular form.

A rotating member of the seal of the invention may include at least one non-continuous, circumferentially and radially extending portion.

Preferably, a seal of the invention may include at least one magnetic member which is radially and axially restrained in the housing by a housing groove, said groove preferably incorporated at least one inwardly radially extending indentation adjacent to a magnet to provide circumferential anti-rotation of said magnet in said groove.

A seal of the invention may include at least one seal face holder, said seal face holder having magnetic attraction properties. A mechanical seal of the invention may contain at least two seal faces, axially restrained in a housing, the first seal face having the ability to rotate with a shaft or other item of rotating equipment, and the second seal face being non-rotatable with respect to the housing of the rotation equipment. Either the rotating seal face and/or the stationary seal face may be housed and/or secured, permanent or otherwise, in a seal face holder.

A mechanical seal of the invention may have at least three seal faces, preferably, but not essentially, longitudinally restrained in a housing. The first seal face may have the ability to rotate with a shaft or other item of rotating equipment and the second and third seal faces may be non-rotatable with respect to the housing of the rotating equipment. Equally, said three seal faces may include two seal faces having the ability to rotate with a shaft or other item of rotating equipment and the third seal face being non-rotatable with respect to the housing of the rotating equipment.

Embodiments of mechanical seals in accordance with the present invention may be such that at least one rotary member and/or one stationary member can be mechanically attached to the items of rotary equipment.

A seal of the invention may include a housing having at least one longitudinal through hole or slot for accommodating a stud or bolt in an item of rotating equipment, thereby allowing the housing of the mechanical seal to be secured to the rotating equipment.

Preferably, a seal of the invention includes at least two counter opposed magnetic members, said first magnetic member attracting a first axially floating seal face and a second magnetic member attracting a second axially floating seal face.

Preferably, a seal of the invention includes lubrication means for feeding lubricant to the contacting seal faces. A cavity may be provided between at least two sets of sliding surfaces and said cavity may be connected to the lubrication means which acts automatically to fill the cavity with lubrication fluid.

A seal of the invention may be a double mechanical seal of a size small enough to fit in a space having a radial cross section as small as 1.5 mm, but preferably larger. A double mechanical seal in accordance with the present invention may be small enough to fit in a space having a longitudinal dimension as small as 6 mm but preferably larger.

### DESCRIPTION OF THE DRAWINGS

The accompanying drawings are as follows:

FIG. 1 is a longitudinal cross-section through an item of rotating equipment with an oil mist system connected to the bearing chamber;

FIG. 2A is a longitudinal cross-section of the first embodiment of the invention, showing one textured seal face adjacent to the sealed fluid;

FIG. 2B corresponds to FIG. 2A and shows an end view through the centre of the rotary seal face on line A-A of the first embodiment;

FIG. 2C corresponds to FIG. 2A and is an enlarged partial longitudinal section of the textured seal face of the first embodiment;

FIG. 3 corresponds to FIG. 2A and shows the end view of the textured seal face only on line B-B of the first embodiment;

FIG. 4 is a partial longitudinal cross-section of a second embodiment of the invention, showing one textured seal face adjacent to the atmospheric side;

FIG. 5 corresponds to FIG. 2B and shows the end view of the textured seal face, on line B-B of the third embodiment, with a radial cavity adjacent to the hermetic seal face;

FIG. 6 is a partial longitudinal cross-section of a fourth embodiment of the invention, showing two textured seal faces;

FIG. 7A shows an alternative end view of a textured seal face on line E-E of FIG. 6

FIG. 7B shows an alternative end view of a partially textured seal face on line D-D of FIG. 6;

FIG. 8 is a partial longitudinal section through a fifth embodiment of the invention which is a bearing protector of the invention, showing a combined labyrinth seal and hermetic seal;

FIG. 9 is a partial longitudinal section through a sixth embodiment of the invention which is an item of rotating equipment with an oil mist system connected to the radial cavity between the textured and hermetic seal faces;

FIG. 10 is a longitudinal section through a seventh embodiment of the invention, showing a concentric pair of seal faces, with one textured seal face adjacent to the sealed fluid; and

FIG. 11 corresponds to FIG. 10 and shows the end view on line C-C of the seventh embodiment.

### DETAILED DESCRIPTION OF THE INVENTION

The invention will now be described, by way of examples only, with reference to the accompanying drawings.

In general, rotary seals in accordance with the present invention may be used not only in the case where the shaft is a rotary member and the housing is a stationary member but also the reverse situation, that is to say, in which the shaft is stationary and the housing is rotary.

Furthermore, the invention may be embodied in both rotary and stationary arrangements, that is to say, the axially floating face or faces may be either rotary or stationary.

The invention may also be embodied in cartridge and component seal formats with metallic components as well as non-metallic components in both single and double seal formats. Double seal formats include tandem, face-to-face or back-to-back orientations in a series or concentric arrangement.

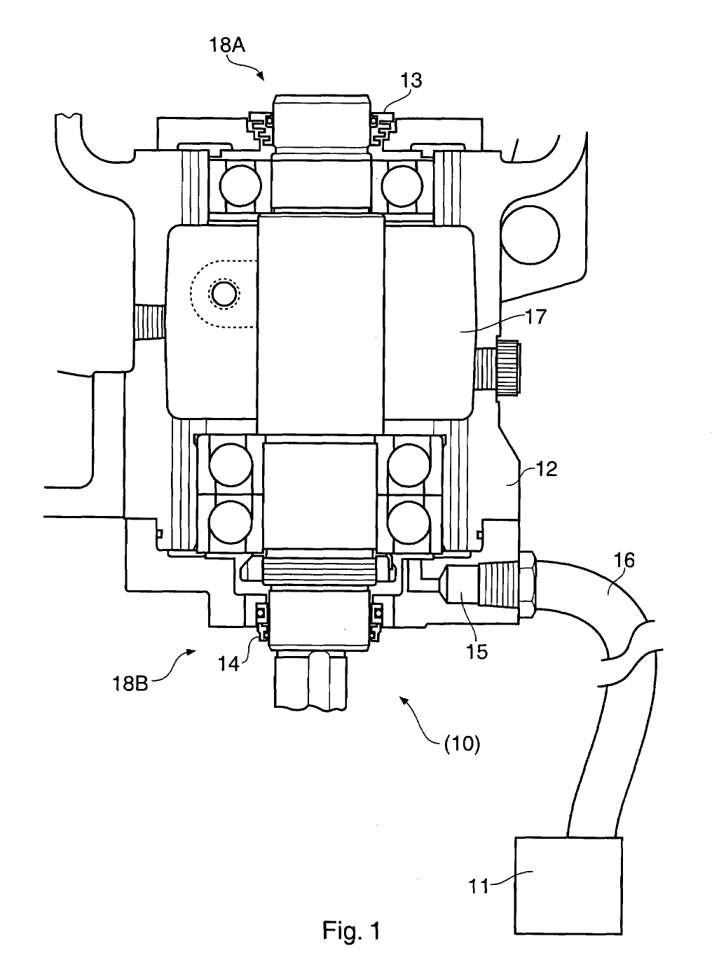

Referring to FIG. 1 of the accompanying drawings, there is illustrated a longitudinal cross-section through an item of rotating equipment 10 with an oil mist system 11 connected to the bearing chamber 12. One side of the bearing chamber 12 incorporates a traditional non-contacting bearing protector such as a labyrinth seal 13 and the other side incorporates a single mechanical seal 14.

The oil mist is supplied through the feed pipe 16 from the oil mist system 11 to the bearing cavity 17 via inlet 15. The non-contacting labyrinth seal 13 allows the oil mist to exit the bearing cavity 17 to the atmosphere 18A. This is considered to be environmentally unacceptable. The single mechanical seal 14 has insufficient lubrication from the oil mist to be able to function correctly and thus is prone to overheating and seal face deterioration—eventually leaking oil mist to the atmosphere 18B.

Reference here is made to our co-pending patent application (PCT/GB03/02941 Roddis) which preferably defines a hermetic dual face bearing protector with magnetic attracted seal faces in a cartridge seal format. Like all mechanical seal face designs, the bearing isolator defined in PCT/GB03/02941 may suffer from overheating in marginal lubrication applications as found with oil mist.

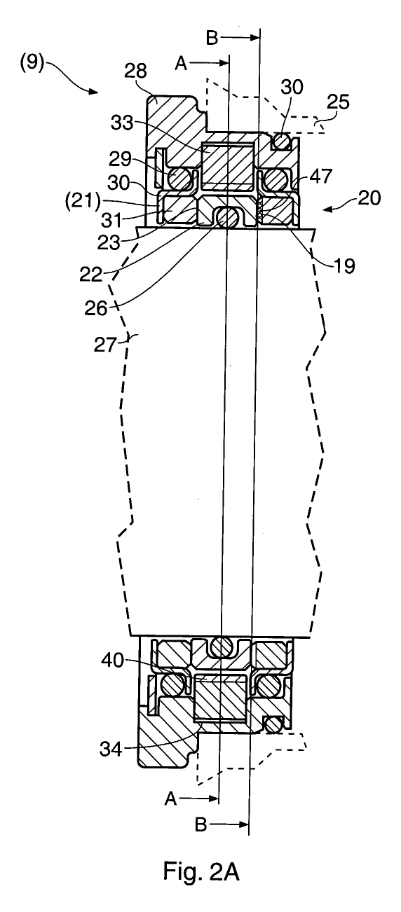

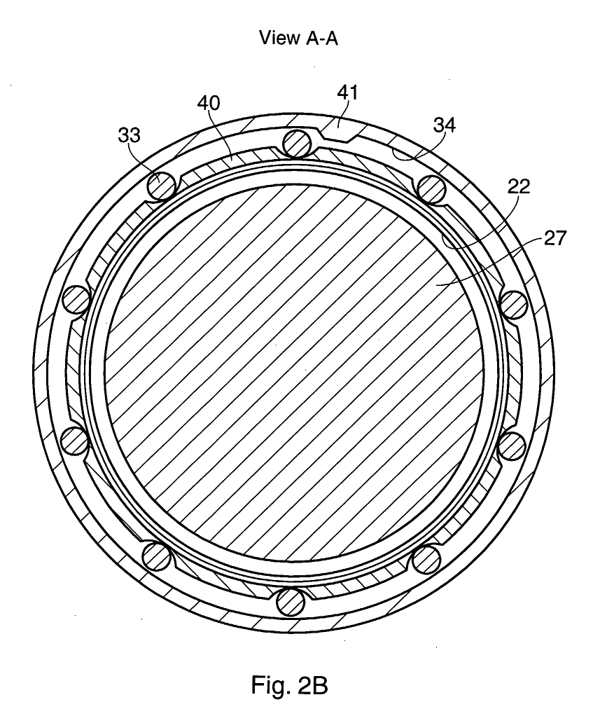

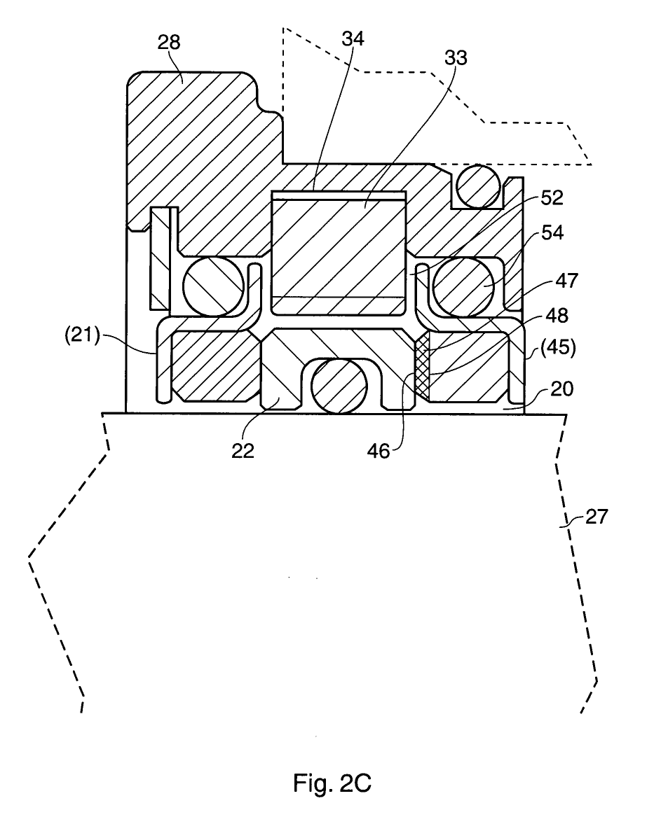

FIG. 2A is a longitudinal cross-section of the first embodiment of the invention, showing a dual bearing protection mechanical seal 9 with one textured seal face 19 adjacent to the sealed fluid 20. The sealed fluid 20 is an oil mist in this example. However, it could be any marginal lubrication media including grease, powder or a slurry combination.

The mechanical seal 9 includes a stationary and axially floating seal face assembly 21 which is magnetically spring biased towards a static rotary seal face 22. Rotary seal face 22 slides on static seal face 21, the interface between the seal faces forming a sealing area 23. This sealing area 23 is the primary seal that prevents fluid medium 20 from escaping from the bearing chamber 25.

Fluid medium 20 is also sealed by a rotary elastomer 26 which contacts shaft 27, thereby forming a first secondary sealing area. A second secondary sealing area is formed between stationary seal face 21 and stationary housing 28 by means of elastomeric member 29. A third secondary sealing area is formed between the stationary housing 28 and the bearing chamber 25 by means of elastomeric member 30.

The primary and secondary sealing area prevent the fluid medium 20 from escaping from the bearing chamber 25.

The static seal face 21 is prevented from rotating by one or more drive lugs/pins between seal face holder 30 and housing 28. In other embodiments, alternative anti-rotation arrangements may be provided.

The rotary seal face 22 rotates with the shaft 27 due to radial squeeze between the elastomeric member 26 and the shaft 22. Again, alternative rotational drive devices can be utilised in other embodiments of the invention.

Stationary seal face 21 is a shrink fitted, two part design. A first, radially inward part is a seal running face 31 which is typically manufactured from a mechanical seal face material such as carbon, tungsten carbide, silicon carbide or a ceramic material.

The second radially outward part of the seal face 21 is a seal face holder 30, which is manufactured from a magnetic material. The interface between the seal face holder 30 and the seal running face 31 is preferably sealed by means of a suitable adhesive, or a radial interference fit.

The two part stationary seal face 21 is longitudinally attracted to the housing 28 by magnets 33. These magnets 33 are each in the form of a cylindrical bar magnet located in an outwardly extending radial groove 34 in housing 28. In other embodiments, magnets of different shapes and sizes may be employed.

The magnets 33 are preferably radially positioned and circumferentially spaced by magnet support ring 40. Preferably, the radial groove 34, in housing 28 incorporates an inwardly extending radial lug 41 over a segment of the circumference of the groove 34 as shown in FIG. 2B.

FIG. 2B corresponds to FIG. 2A and shows a cross-sectional end view through section A-A. As shown, the magnet support ring 40 carries one or more cylindrical magnets 33, which circumferentially locate against inwardly extending radial lug 41 in groove 34. This arrangement provides an anti-rotation feature between the support ring 40 and static bearing housing 25 (FIG. 2A), which is considered particularly beneficial should the rotor 22 and/or shaft 27 be radially misaligned and contact the support ring 40.

FIG. 2C is an enlarged partial cross-section, corresponding to FIG. 2A. Located on the other side of rotary seal face 22 to stationary seal face 21 is a static seal face assembly 45. The magnets 33 also attract static seal face 45 towards the rotary seal face 22 and the rotary seal face 22 slides on the static seal face 45. The interface between rotary seal face 22 and stationary seal face 45 provides sliding area 46, which is not a sealing surface.

The static sliding seal face 45 has a textured surface 47 which creates at least one communication channel 48 between the innermost radial portion 49 and the outermost radial portion 50 of the seal face.

As the rotary seal face 22 wipes past the textured stationary seal face 45, energy is added to the adjacently positioned oil mist particles 20. This flow turbulence acts to cause the larger oil particles to be deposited around the seal faces. The rate of particle deposition increases with increasing turbulence induced by higher velocities. It has been found that the generated turbulence of a textured seal face 45 is significantly greater than that of an untextured seal face 21. Said textured seal face 45 turbulence is sufficient to coalesce the oil mist 20 into droplets to provide an efficient wetting of the sliding seal faces 23 and 46.

As the larger oil droplets 20 coalesce, the centrifugal forces of the rotating shaft 27 throw them radially outwardly through the stationary communication channel(s) 48 in the textured stationary seal face 45 and into the seal cavity 52. Once in the seal cavity 52, the oil droplets 20 gather and are trapped in the radially extending housing groove. This entrapment creates an oil pool 53 which is adjacent to the hermetic sealing interface 21 thus cooling and lubricating it.

A fourth secondary sealing area is formed by elastomer 54 in radial contact with stationary seal face assembly 45 and housing 28.

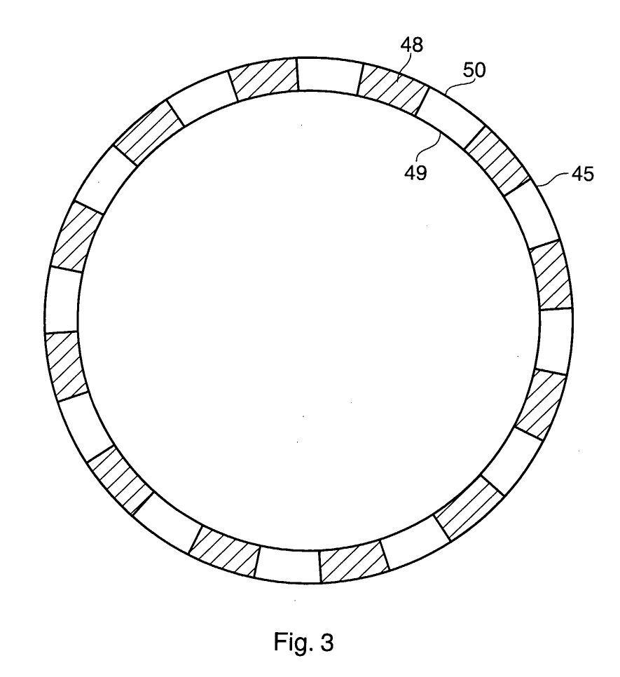

FIG. 3 corresponds to FIG. 2A and shows the end view of the textured seal face 47 on line B-B of the first embodiment.

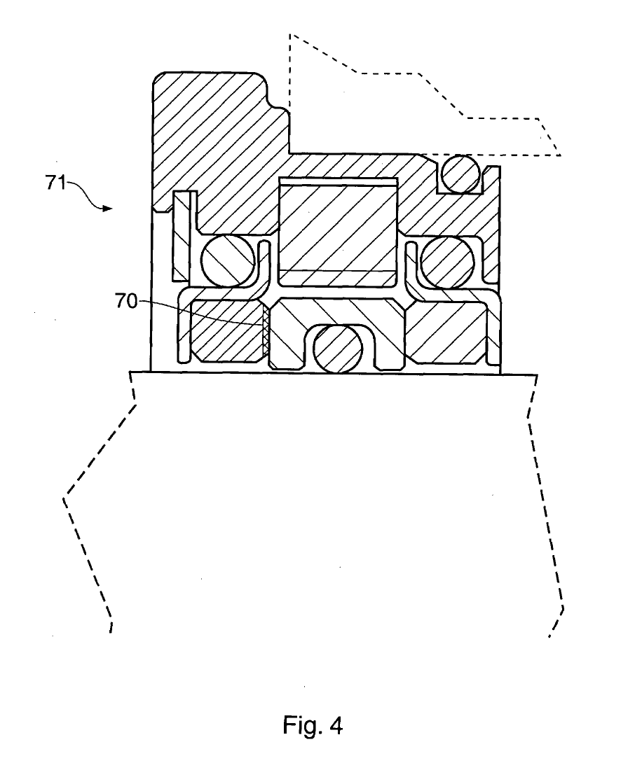

FIG. 4 is a longitudinal section of the second embodiment of the invention, showing one textured seal face 70 adjacent to the atmospheric side of the bearing cavity 71.

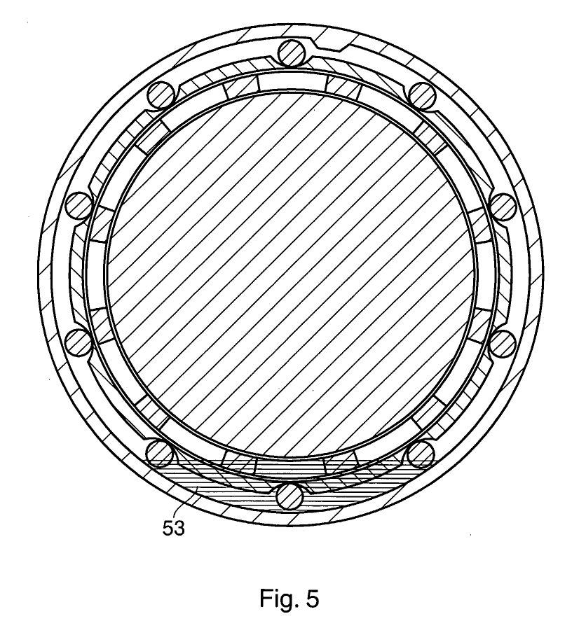

FIG. 5 corresponds to FIG. 2A and shows the end view of the textured seal face 47 on line B-B of the third embodiment. The position of the entrapped oil pool 53 is clearly shown.

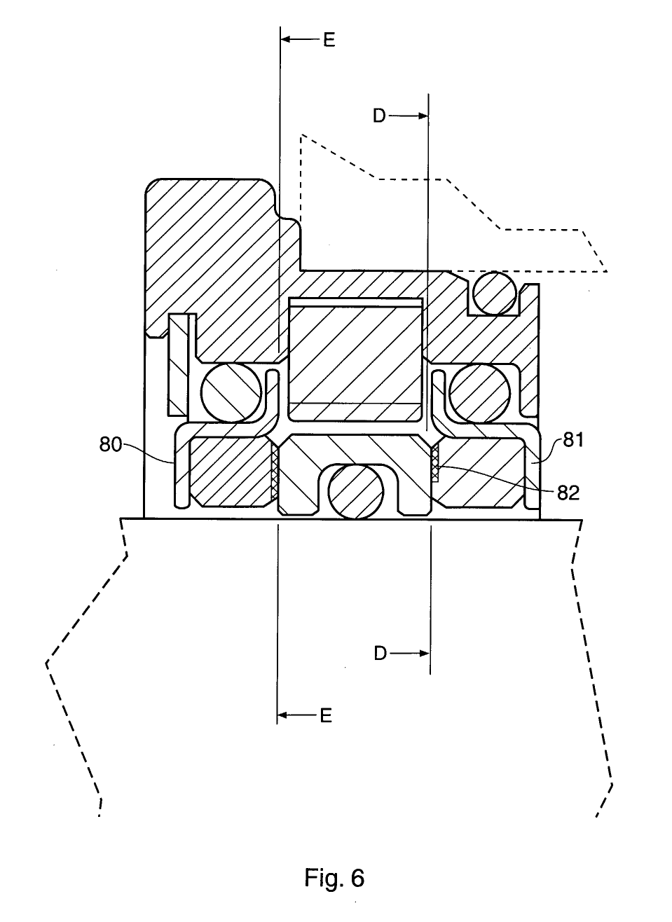

FIG. 6 is a partial longitudinal section of the fourth embodiment of the invention, showing the two sets of textured seal faces 80 and 81 of the first and second embodiments, albeit textured seal face 81 is only partially textured across its radial width. Any combination of the first, second and fourth embodiments could be provided with any combination of patterns and by any suitable combination of marking, engraving, texturing, and etching techniques of either seal face in the seal assembly.

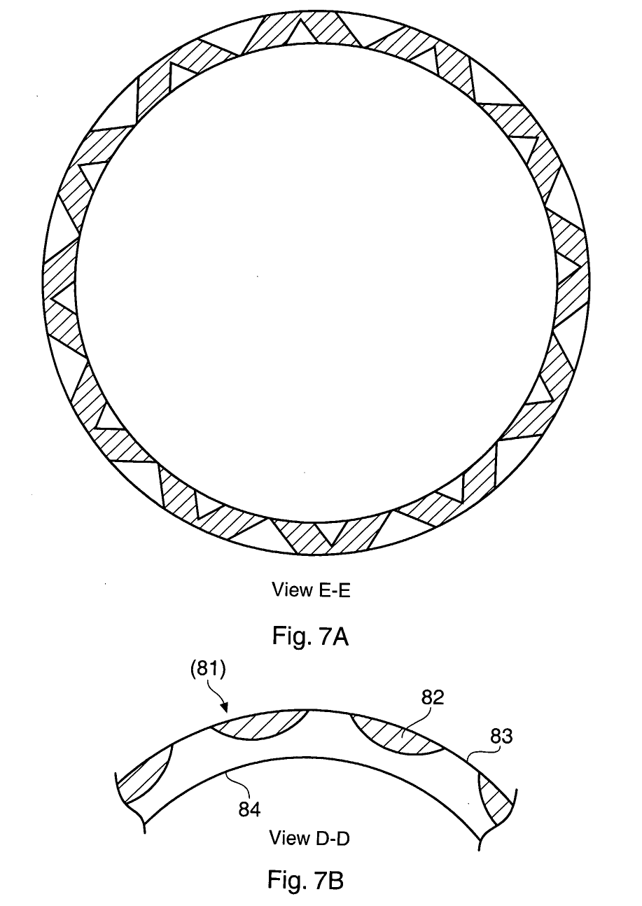

An example is shown in FIG. 7A which is an end view of an alternative textured seal face, on line E-E of FIG. 6. FIG. 7B shows an end view of the partially textured seal face 82, on line D-D of FIG. 6. Preferably, the partial texture 82 extends from the region of the face in contact with the oil pool. In the case of FIG. 6, the texture 82 extends from the outermost radial position 83 of the seal face 81 radially inwardly, terminating before communicating with the innermost radial portion 84 of seal face 81.

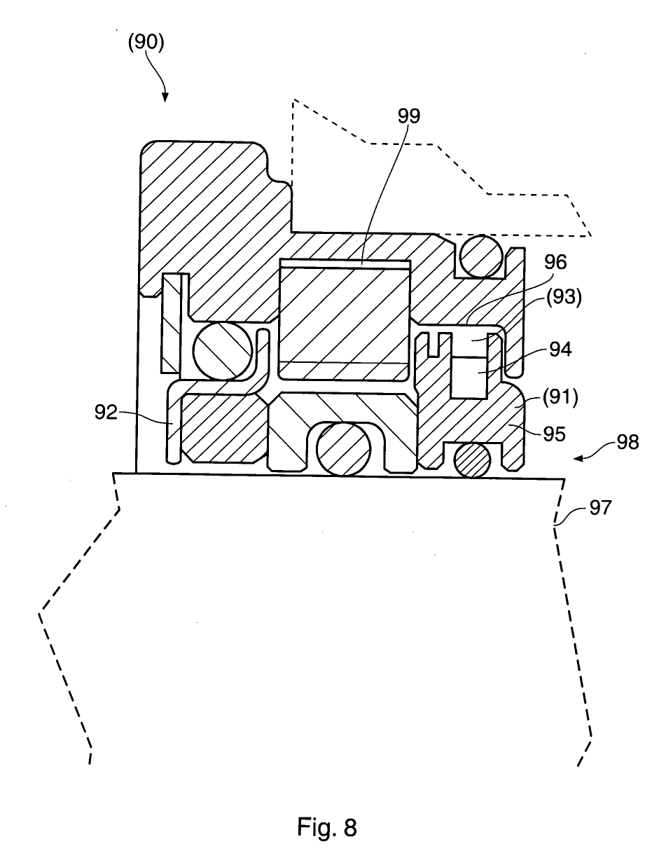

FIG. 8 is a partial longitudinal section through a fifth embodiment of a bearing protector of the invention 90, showing a combined labyrinth seal 91 and hermetic seal 92. Labyrinth seal 91 incorporates an agitating feature 93 in the form of one or more inwardly radially extending scallops 94 in the rotor 95 which are adjacently positioned in close radial position to a stator bore 96. As such, as the rotor 95 rotates with the shaft 97, the agitator 93 adds energy into the oil mist 98 acting to coalesce it into oil droplets. Said oil droplets 98 collect in a radially extending oil pool cavity 99 thus providing a lubrication and cooling to the hermetic sliding seal face 92.

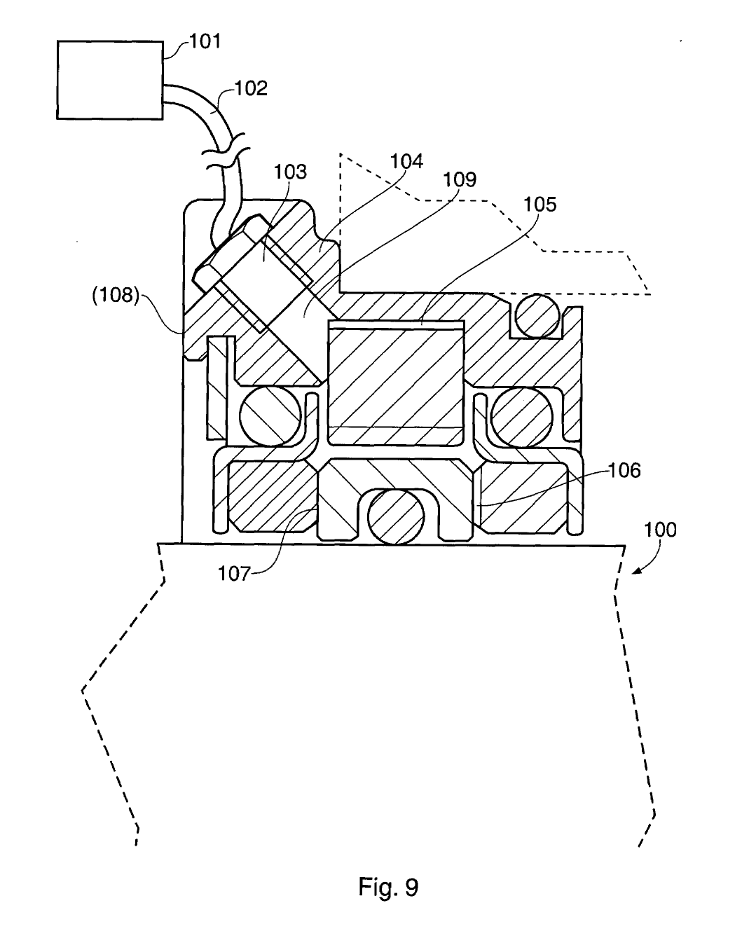

FIG. 9 is a partial longitudinal section through a sixth embodiment of the present invention which is an item of rotating equipment 100 with an oil mist system 101 connected by suitable pipework 102 to an orifice 103 in the bearing protector housing 104. Orifice 103 communicates with the radial cavity 105 between the textured sliding seal face 106 and hermetic sliding seal face 107. Oil mist 109 is forced through bearing protector 108 before passing through to the bearings in the rotating equipment 100. This ensures maximum oil droplet collection, and thus seal face cooling, adjacent to the hermetic sliding seal face 107.

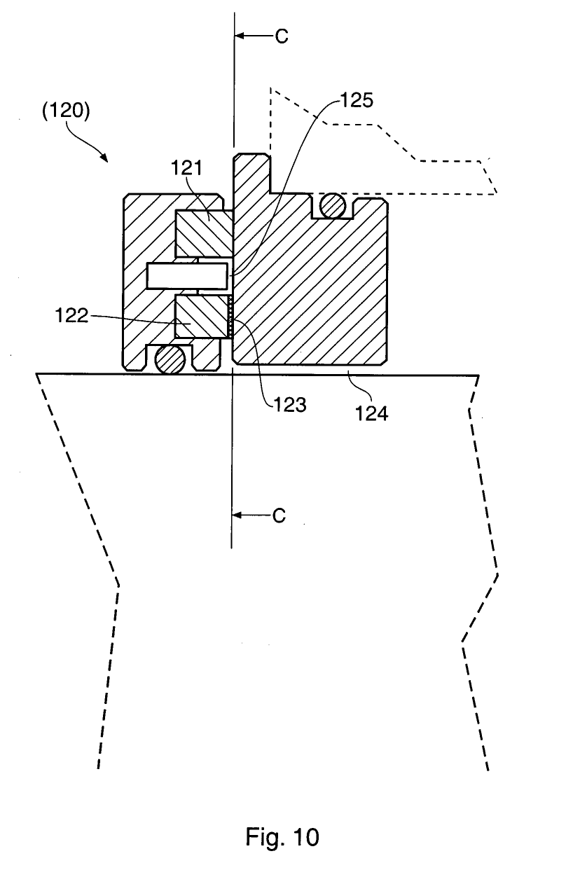

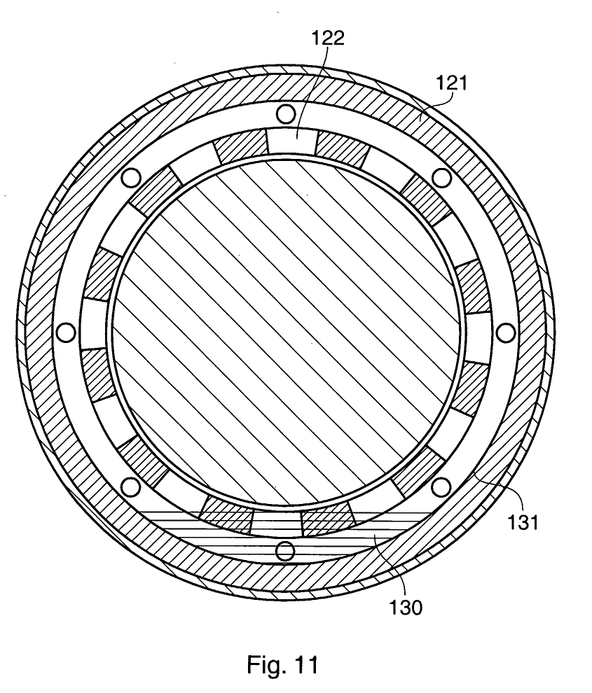

FIG. 10 is a longitudinal section through the seventh embodiment of the invention 120, showing a concentric pair of seal faces 121 and 122, the radially inwardly positioned one being textured 123 and positioned adjacent to the sealed fluid 124. As previously described, oil mist 124 coalesces and passes through the textured sliding surface 123 into the seal chamber cavity 125. As illustrated in FIG. 11, the coalesced oil gathers in an oil pool 130 in the radially and/or axially extending cavity positioned adjacent to the hermetic seal face.

Since the seal faces 121 and 122 are concentrically mounted, the radially outwardly positioned hermetic seal face 121 bathes in the gathered pool of oil droplets 130. Again, this arrangement provides excellent seal face lubrication to the hermetic sliding seal faced 121.

1-23. (canceled)

24. A rotary seal, comprising:
a floating seal face;
a stationary seal face in a sealing relationship with said floating seal face for forming a pair of sealing faces, with a fluid collection cavity adjacent said floating seal face and said stationary seal face;
means for introducing a lubricant in a vicinity of the fluid collection cavity; and,
means for promoting coalescence of the lubricant accumulates in the fluid collection cavity and lubricates said floating seal face and said stationary seal face.

25. The rotary seal according to claim 24, wherein said means for promoting coalescence of the lubricant includes at least one of a textured seal face surface, at least one groove or slot, and a pumping element.

26. The rotary seal according to claim 24, further comprising magnetic biasing means for urging said floating seal face towards said stationary seal face.

27. The rotary seal according to claim 26, wherein said floating seal face and said magnetic biasing means are rotationally fixed relative to one another and said stationary seal face is free to rotate relative to said floating seal face.

28. The rotary seal according to claim 26, wherein said magnetic biasing means is non-rotating.

29. The rotary seal according to claim 28, wherein said magnetic biasing means is axially restrained in an internal groove of a non-rotating housing.

30. The rotary seal according to claim 28, wherein said magnetic biasing means comprises at least two magnets circumferentially separated by a spacing element.

31. The rotary seal according to claim 30, wherein said spacing element includes at least one castellation extending radially from a support member positioned radially inwardly of said at least two magnets.

32. The rotary seal according to claim 24, further comprising an additional floating seal face and an additional stationary seal face in a sealing relationship for forming an additional pair of sealing faces, with at least one of said pair of sealing faces or said additional pair of sealing faces having a textured surface.

33. The rotary seal according to claim 32, wherein said pair of sealing faces and said additional pair of sealing faces are longitudinally spaced apart.

34. The rotary seal according to claim 32, wherein said pair of sealing faces and said additional pair of sealing faces are radially spaced apart.

35. The rotary seal according to claim 24, wherein said rotary seal includes two substantially identical pairs of said pair of sealing faces.

36. The rotary seal according to claim 24, wherein said rotary seal includes at least one symmetrical seal face when viewed at approximately 90° to a shaft on which said rotary seal, when in use, is mounted.

37. The rotary seal according to claim 24, further comprising a magnet having a first end for attracting a first said floating seal face and a second end of said magnet for attracting an additional floating seal face, said additional floating seal face being a second said floating seal face.

38. The rotary seal according to claim 24, further comprising a first counter-opposed magnet for attracting a first said floating seal face and a second counter-opposed magnet for attracting a second said floating seal face.

39. The rotary seal according to claim 24, further comprising lubrication means for feeding lubricant to a region where said floating seal face and said secondary seal face are contacting one another.

40. The rotary seal according to claim 39, wherein said lubrication means includes means for supplying an oil mist to the region where said floating seal face and said secondary seal face are contacting one another.

41. The rotary seal according to claim 24, wherein said rotary seal is a double mechanical seal.

42. The rotary seal according to claim 24, wherein said rotary seal is a hermetic seal or a repeller bearing protector.

43. The rotary seal according to claim 24, wherein said rotary seal includes a labyrinth seal.
